(19) United States
(12) Patent Application Publication
(10) Pub. No.: US 2007/0153234 A1
(43) Pub. Date: Jul. 5, 2007

(54) Display device for volumetric imaging using a birefringent optical path length adjuster

(75) Inventors: Bart A. Salters, Eindhoven (NL); Levinus P. Bakker, Helmond (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,877

(22) PCT Filed: Jan. 6, 2005
(86) PCT No.: PCT/IB05/50074

§ 371 Date: Jun. 28, 2006

(30) Foreign Application Priority Data
Jan. 9, 2004 (GB) 0400370.3

(51) Int. Cl. G03B 21/00; G02B 27/22

(52) U.S. Cl. 353/8; 359/462

(57) ABSTRACT

A display device for generating a three-dimensional volumetric image incorporates an optical path length adjuster enables electro-optical control of a physical path length between a display panel and a focusing element, to generate a virtual image within a defined imaging volume. The adjuster varies an optical path length between an input optical path and an output optical path and includes: a first polarisation switch for selecting a polarisation state for an input beam on the input optical path and an optical element having birefringent properties and thereby defining at least two possible effective optical paths of different lengths therethrough, for passing the input beam along a selected one of said at least two possible optical paths according to the selected polarisation state of the input beam and for providing an output beam of light, on said optical output path, that has travelled along the selected optical path.

The present invention relates to methods and apparatus for adjusting an optical path length between two optical elements. In particular, though not exclusively, the invention relates to adjustment of an optical path length within three dimensional display devices that generate a virtual image within a defined imaging volume.

A three-dimensional image can be created in several ways. For instance, in stereoscopic displays two pictures uniquely observable by each of a viewer's eyes can be shown simultaneously or time-multiplexed. The pictures are selected by means of special spectacles or goggles worn by the viewer. In the former case, the spectacles may be equipped with Polaroid lenses. In the latter case, the spectacles may be equipped with electronically controlled shutters. These types of displays are relatively simple to construct and have a low data-rate. However, the use of special viewing spectacles is inconvenient and the lack of motion parallax may result in discomfort among viewers.

A more realistic three-dimensional impression can be created using an auto-stereoscopic display. In these types of display, every pixel emits light with different intensities in different viewing directions. The number of viewing directions should be sufficiently large that each of the viewer's eyes sees a different picture. These types of display show a realistic motion parallax; if the viewer's head moves, the view changes accordingly.

Most of these types of display are technically difficult to realise in practice. Several proposals can be found in the literature, see for instance U.S. Pat. No. 5,969850. The advantage of these displays is that a number of viewers can watch, e.g. a single 3D television display without special viewing spectacles and each viewer can see a realistic three-dimensional picture including parallax and perspective.

Another type of 3D display is a volumetric display as described at http://www.cs.berkley.edu/jfc/MURI/LC-display. In a volumetric display, points in an image display volume emit light. In this way, an image of a three dimensional object can be created. A disadvantage of this technique is occlusion, i.e. it is not possible to block the light of points that are hidden by other objects. So, every object displayed is transparent. In principle, this problem can be overcome by means of video-processing and possibly tracking of the position of the viewers head or eyes.

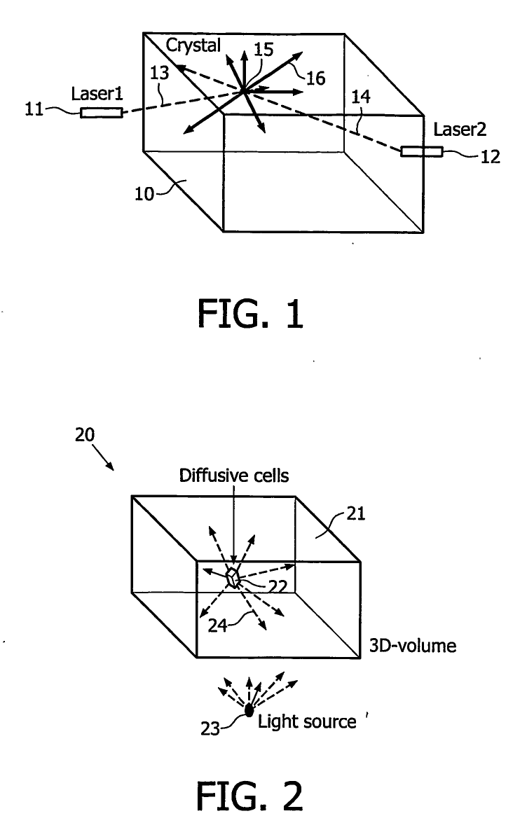

A known embodiment of a volumetric display is shown in FIG. 1. The display consists of a transparent crystal 10 in which two lasers 11, 12 (or more) are scanning. At the position 15 of intersection of the laser beams 13, 14, light 16 may be generated by up-conversion, where photon emission at a higher energy occurs by absorption of multiple photons of lower energy (i.e. from the combined laser beams). This type of display is expensive and complicated. A special crystal 10 and two scanning lasers 11, 12 are required. In addition, up-conversion is not a very efficient process.

An alternative embodiment of volumetric display 20 is shown in FIG. 2. This arrangement uses a material that can be switched between transparent and diffusive, such as polymer dispersed liquid crystal (PDLC) or liquid crystal gel (LC-gel). In a three-dimensional grid volume 21, cells 22 can be switched between these two states. Typically, the volume 21 is illuminated from one direction. In the illustration, the illumination source 23 is located below the grid volume. If a cell 22 is switched to a diffusive condition, light 24 is scattered in all directions.

One object of the present invention is to provide a volumetric three-dimensional image display device that overcomes some or all of the problems associated with prior art devices.

Another object of the present invention is to provide an apparatus suitable for adjusting an optical path length between two optical elements within a volumetric three-dimensional image display device.

A further object of the present invention is to provide an optical path length adjuster for varying an optical path length between an input optical path and an output optical path.

Some or all of these objects may be achieved by embodiments of the invention as described herein.

According to one aspect, the present invention provides a display device for generating a three-dimensional volumetric image, comprising:

a two-dimensional image display panel for generating a two-dimensional image;

a first focusing element for projecting the two-dimensional image to a virtual image in an imaging volume; and

means for altering the effective optical path length between the display panel and the projecting first focusing element so as to alter the position of the virtual image within the imaging volume, wherein the means for altering the effective optical path length includes an optical path length adjuster for varying an effective optical path length between an input optical path and an output optical path, comprising:

a first polarisation switch for selecting a polarisation state for an input beam on the input optical path; and

an optical element having birefringent properties and thereby defining at least two possible effective optical paths of different lengths therethrough, for passing the input beam along a selected one of said at least two possible optical paths according to the selected polarisation state of the input beam and for providing an output beam of light, on said optical output path, that has travelled along the selected optical path.

According to another aspect, the present invention provides a method for generating a three-dimensional volumetric image, comprising the steps of:

generating a two-dimensional image on a two-dimensional image display panel;

projecting the two-dimensional image to a virtual image in an imaging volume with a first focusing element; and

altering the optical path length between the display panel and the projecting focusing element so as to vary the position of the virtual image within the imaging volume by varying an effective optical path length between an input optical path and an output optical path of an optical path length adjuster positioned between the display panel and the projecting focusing element, comprising the steps of:

selecting a polarisation state for an input beam of light on the input optical path using a first polarisation switch;

passing the input beam into an optical element having birefringent properties and thereby defining at least two possible effective optical paths of different lengths therethrough, the input beam travelling along a selected one of said at least two possible effective optical paths according to the selected polarisation state of the input beam; and

providing an output beam of light, from the birefringent optical element on said optical output path.

Embodiments of the present invention will now be described by way of example and with reference to the accompanying drawings in which:

FIG. 1 shows a perspective schematic view of a volumetric display based on two scanning lasers and an up-conversion crystal;

FIG. 2 shows a perspective schematic view of a volumetric display based on switchable cells of polymer dispersed liquid crystal or liquid crystal gel;

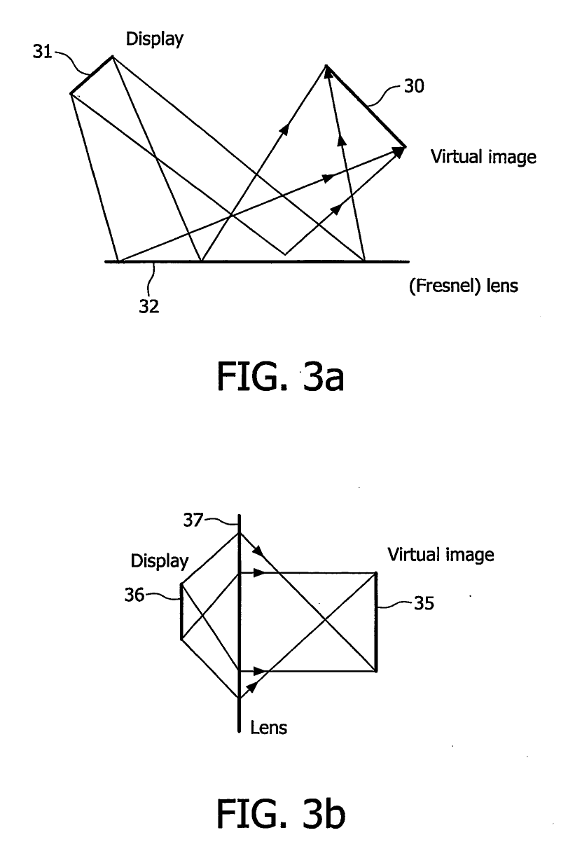

FIG. 3 is a schematic diagram useful in explaining the principles of a volumetric three-dimensional image display device in which the present invention may usefully be deployed;

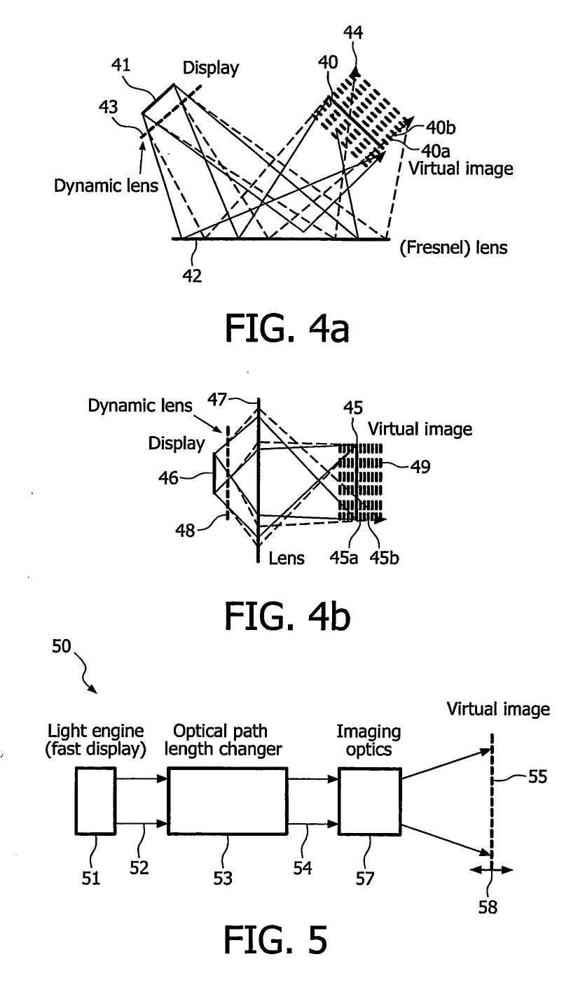

FIG. 4 is a schematic diagram illustrating volumetric three-dimensional image display devices comprising a display panel and an optical path length adjuster according to the present invention;

FIG. 5 is a schematic diagram of a volumetric three-dimensional image display device using an optical path length adjuster between a display panel and a focusing element;

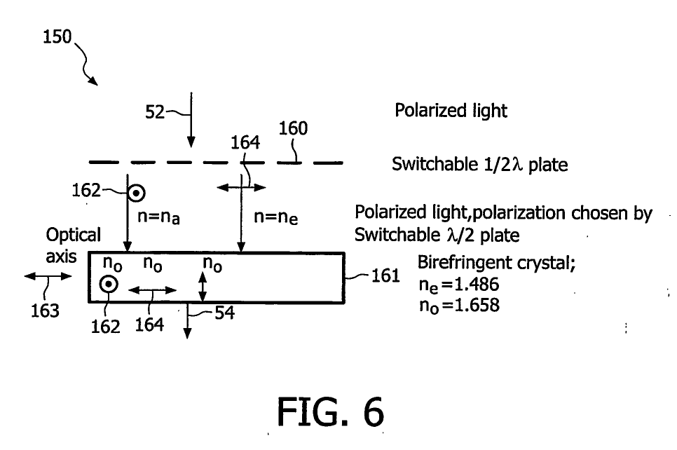

FIG. 6 is a schematic diagram of an optical path length adjuster offering two different path lengths;

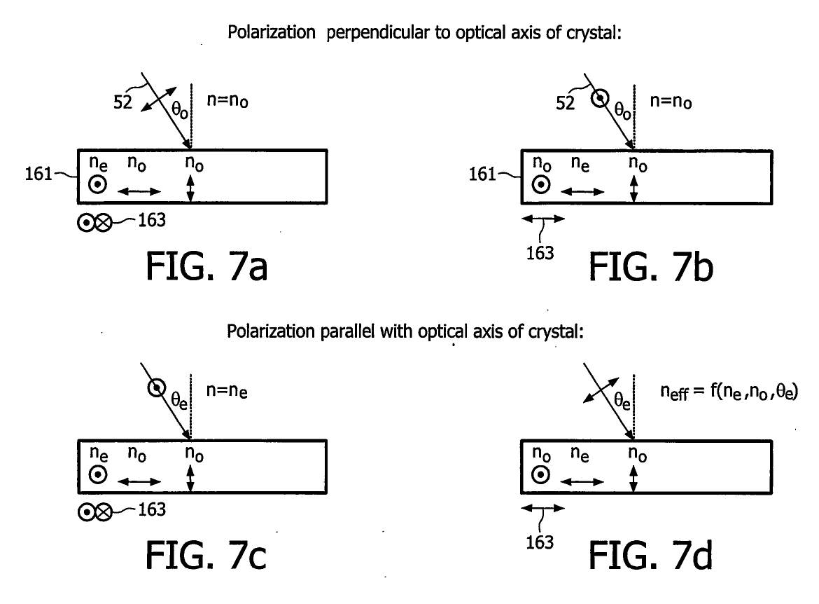

FIG. 7 is a schematic diagram illustrating the effects of orientation of the optic axis of a birefringent optical element with respect to an input polarisation beam;

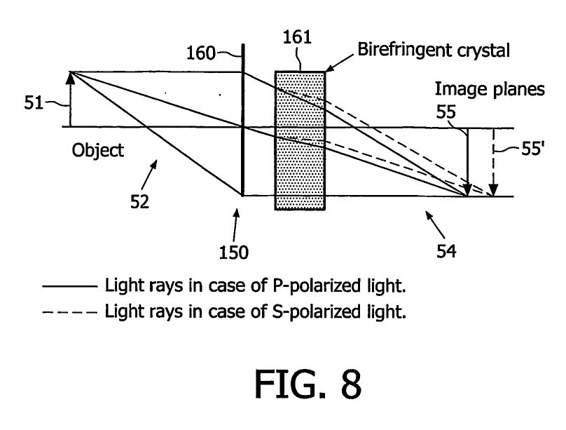

FIG. 8 is a schematic diagram illustrating the two different optical paths of the adjuster of FIG. 6;

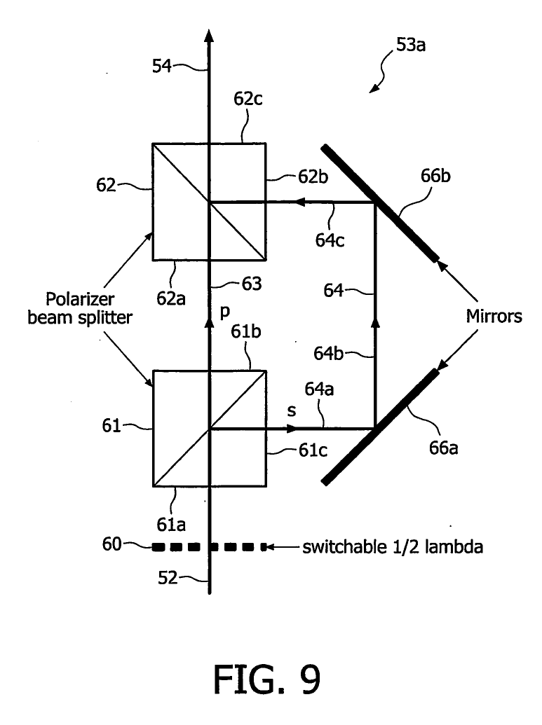

FIG. 9 is a schematic diagram of an optical path length adjuster offering two different path lengths based on beam splitters, which may be used in conjunction with the adjuster of FIG. 6;

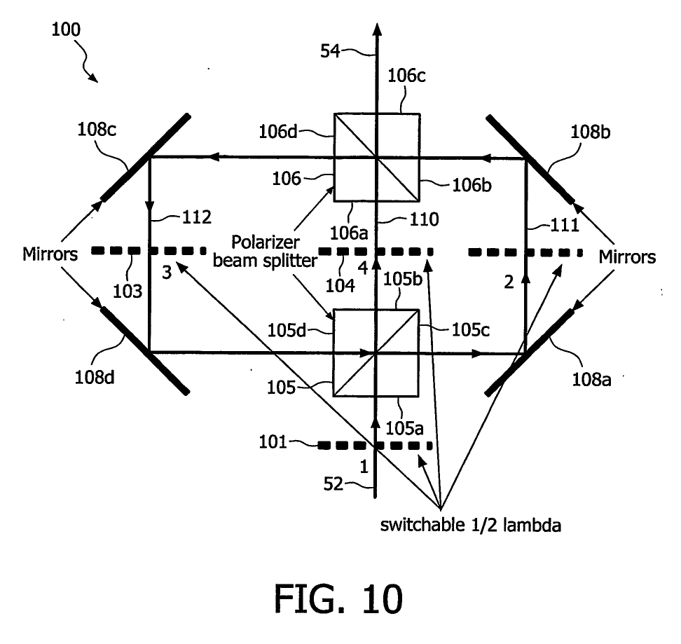

FIG. 10 is a schematic diagram of a folded multi-path optical path length adjuster offering eight different optical paths with seven different path lengths based on beam splitters, which may be used in conjunction with the adjuster of FIG. 6;

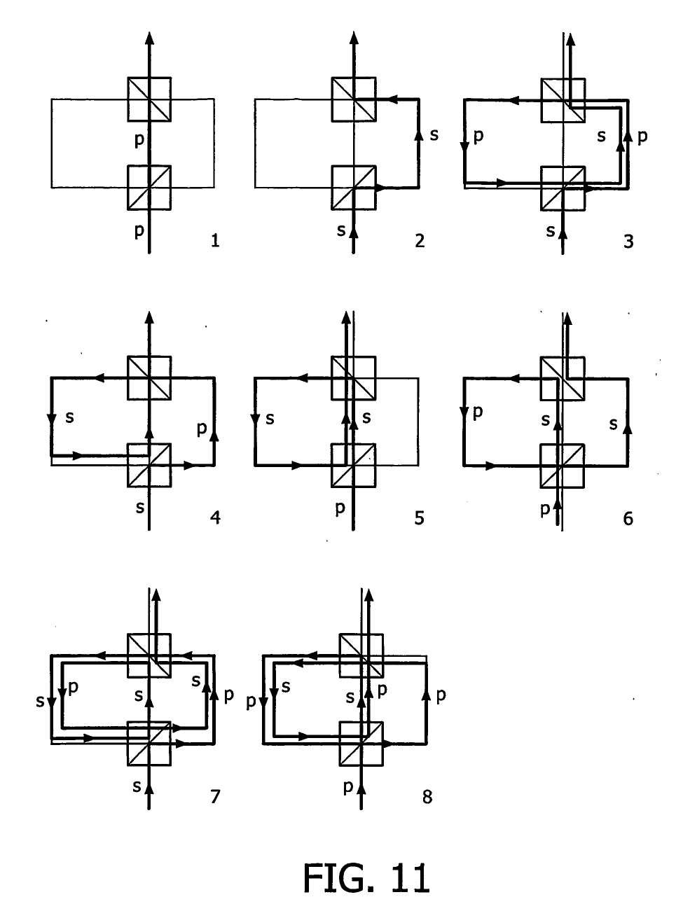

FIG. 11 is a schematic diagram illustrating the eight different optical paths of the adjuster of FIG. 10;

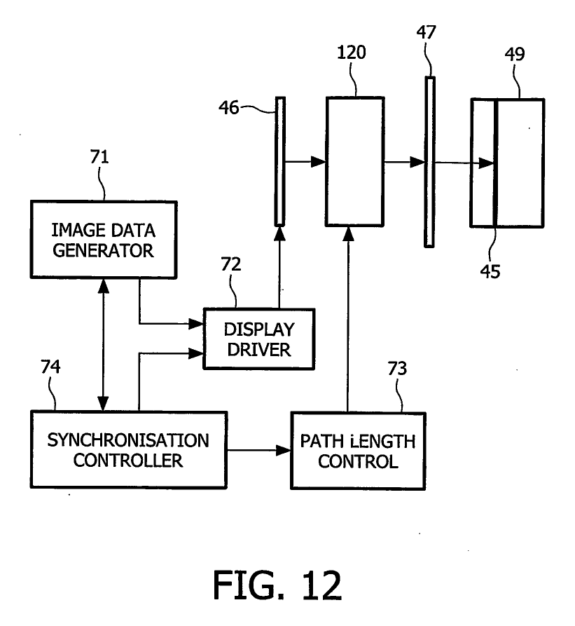

FIG. 12 is a schematic functional block diagram of a control system for the display device of FIG. 5;

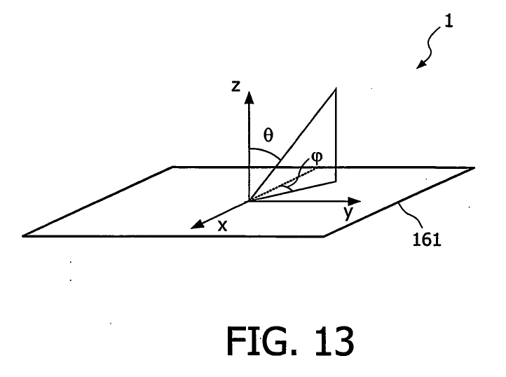

FIG. 13 illustrates the terminology used to define the polar angle and the azimuthal angle of the wave normal within a crystal of birefringent material;

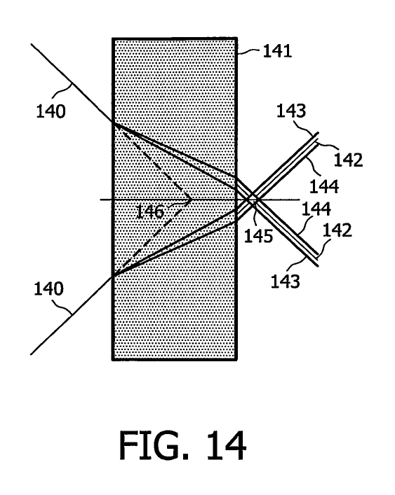

FIG. 14 is a schematic diagram illustrating a converging beam in a birefringent crystal and the various focal points thereof;

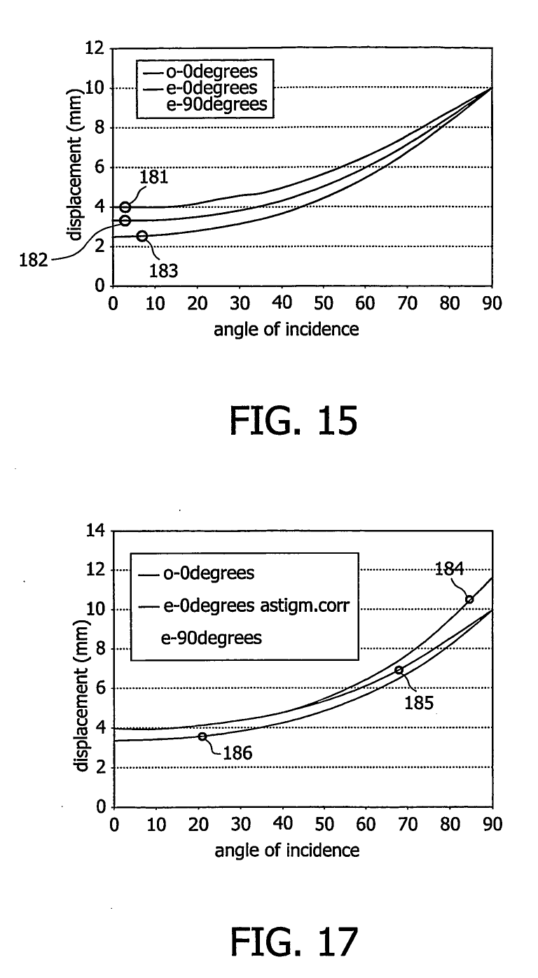

FIG. 15 is a graphical representation of the displacement of the focal points of FIG. 14 as a function of the angle of incidence for each of the ordinary ray, and the extraordinary rays with 0 and 90 degree azimuth angles;

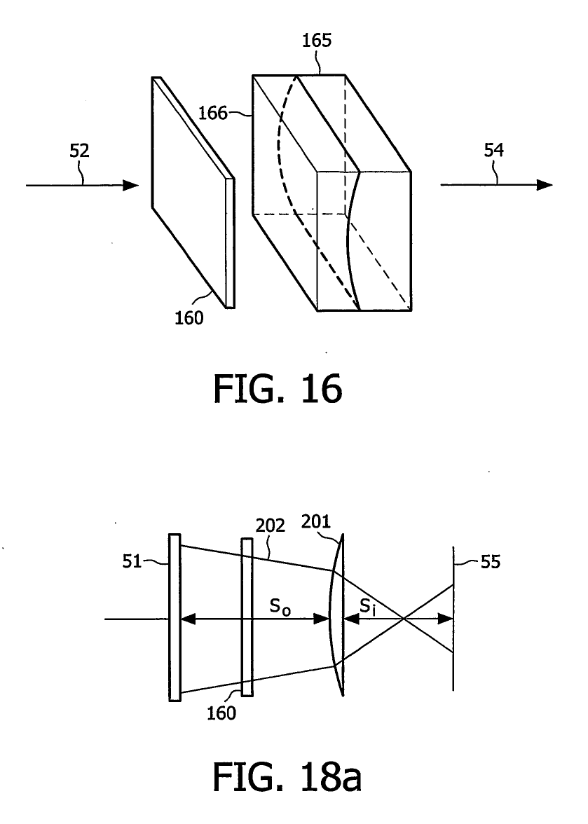

FIG. 16 is a schematic diagram of a cylindrically shaped birefringent element in conjunction with a non-birefringent compensation counterpart for correcting for astigmatism;

FIG. 17 is a graphical representation of the displacement of the focal points for the lens arrangement of FIG. 16 as a function of the angle of incidence for each of the ordinary ray, and the extraordinary rays with 0 and 90 degree azimuth angles;

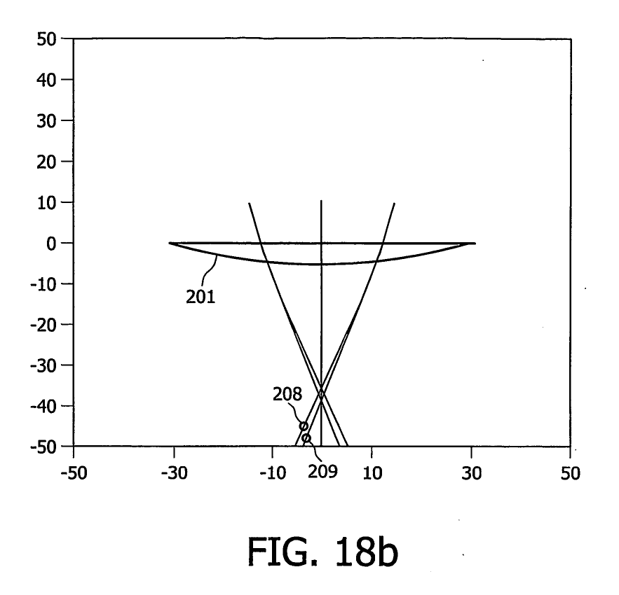

FIGS. 18a and 18b are schematic diagrams of a spherically shaped birefringent element, which can be used in an optical path length adjuster, for which astigmatism is small;

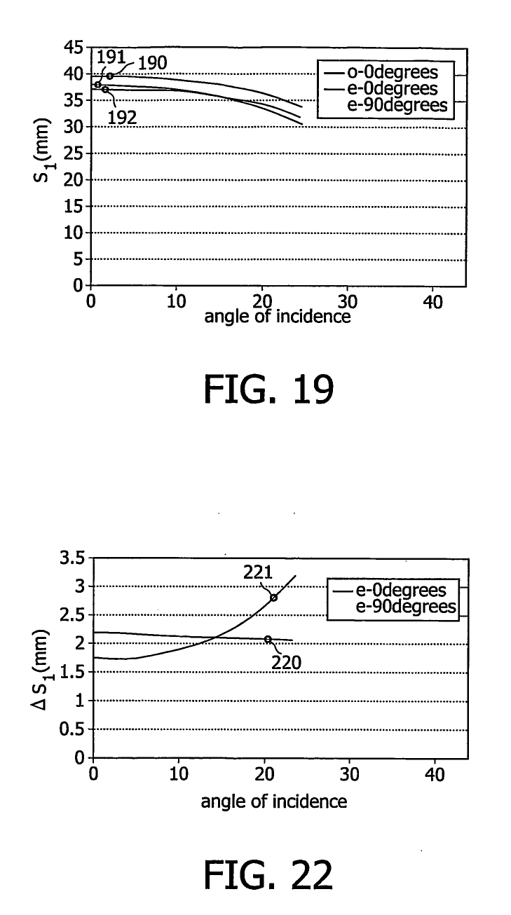

FIG. 19 is a graphical representation of the image distance for each one of the ordinary ray, the extraordinary ray with azimuth angle of 0 degrees and the extraordinary ray with azimuth angle of 90 degrees for a birefringent element according to FIG. 18b;

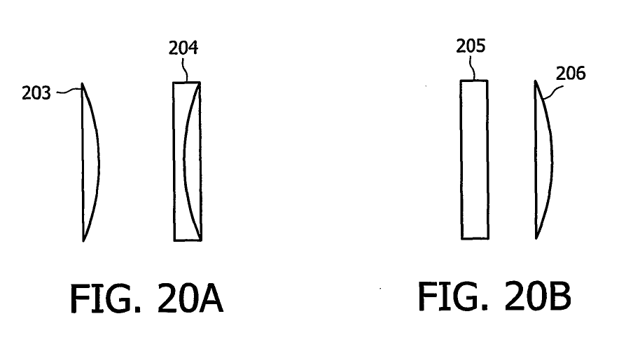

FIGS. 20a and 20b are schematic diagrams of optical elements for correcting spherical aberrations in a birefringent element;

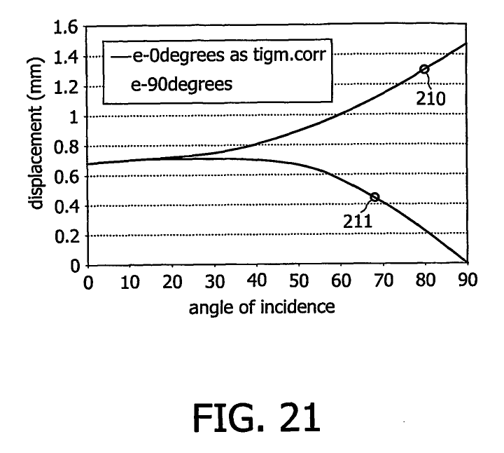

FIG. 21 is a graphical representation of the distance between the focal point of the ordinary ray and (i) the focal point of the extraordinary ray with azimuth angle of 0 degrees, and (ii) the focal point of the extraordinary ray with azimuth angle of 90 degrees, for a cylindrically corrected plane-parallel plate element as in FIG. 16; and

FIG. 22 is a graphical representation of the difference in image distance between the extraordinary images and the ordinary image for extraordinary rays of azimuth angle 0 degrees and 90 degrees for the spherical birefringent lens as shown in FIG. 18b.

FIGS. 3a and 3b illustrate some basic principles used in a three-dimensional image display device. In FIG. 3a, a relatively large virtual image 30 of a small display panel 31 is provided by a Fresnel mirror 32. In FIG. 3b, a relatively large virtual image 35 of a small display panel 36 is provided by a Fresnel lens 37. The virtual image 30 or 35 appears in the air in front of the lens. A spectator can focus on this image 30 or 35 and observes that it is ‘floating’ in the air.

FIGS. 4a and 4b illustrate a modification to the arrangements of FIGS. 3a and 3b. As shown in FIG. 4a, the effective optical path length between the display panel 41 and the Fresnel mirror 42 is varied by the provision of a suitable effective path length adjuster 43. Similarly, as shown in FIG. 4b, the effective optical path length between the display panel 46 and the Fresnel lens 47 is varied by the provision of a suitable effective path length adjuster 48.

In one arrangement which is the subject of a separate patent application filed contemporaneously by the same applicant and entitled “Volumetric Display”, the effective path length adjuster 43, 48 is a variable strength lens; in another arrangement in the same application, the effective path length adjuster is a mechanically-driven device which switches between two or more optical paths by physical movement of one or more optical elements.

In another arrangement which is the subject of a separate patent application filed contemporaneously by the same applicant and entitled “Optical Path Length Adjuster”, the effective path length adjustment is performed electro-optically using a polarisation switch and a pair of beam splitters. The beam splitters are arranged to provide at least two different optical path lengths between them, which paths may be selected by way of the polarisation switch.

The present invention, however, is directed toward electro-optically switching between two or more optical paths within a birefringent optical element.

In a general sense, it will be noted that the mirror 42 or lens 47 may generally be replaced or implemented by any optical focusing element for projecting the two dimensional image of the display panel 41, 46 to a virtual image 40 or 45 located within an imaging volume 44 or 49. Preferably, the mirror 42 or lens 47 is a single or compound optical focusing element having a single focal length such that a planar display panel is imaged into a single plane of an imaging volume.

FIG. 5 illustrates the basic components of the display device 50 30 according to the principles of FIG. 4. A two-dimensional display device or ‘light engine’ 51 provides an illumination source for imaging at an image plane 55. The light travels along an input optical path 52 to an optical path length adjuster 53, and from the optical path length adjuster 53 via output optical path 54 to a focusing element 57 (e.g. mirror 42 or lens 47) which projects the two dimensional image to plane 55.

Operation of the optical path length adjuster 53 effectively moves the depth position of the image plane 55 as indicated by arrow 58. The path length is preferably adjusted periodically at a 3D image display frame frequency. Typically this would be 50 or 60 Hz. Referring back to FIG. 4, during one 3D image frame period (e.g. 1/50 sec), the virtual image of the display panel 41 or 46 fills the imaging volume 44 or 49. Within the same frame period, the display panel may be driven to alter the image that is projected, so that different depths within the imaging volume 44 or 49 receive different virtual images.

It will be understood that in a preferred aspect, the path length adjuster 53 is effective to periodically sweep a substantially planar virtual image of the substantially planar two dimensional display panel through the imaging volume 44 or 49 at a 3D frame rate. Within that 3D frame period, the 2D image display panel displays a succession of 2D images at a 2D frame rate substantially higher than the 3D frame rate.

Therefore, at different planes 40a, 40b or 45a, 45b in the imaging volume 40, 45, different images are obtained so that a three-dimensional image of any object can be constructed.

The two-dimensional display panel may be any suitable display device for creating a two dimensional image. For example, this could be a poly-LED display, a LCD, a LCOS display or a projection display based on a digital micromirror device (DMD).

Preferably, the display panel is sufficiently fast to enable the generation of plural 2D images within one frame period of, e.g. 1/50 sec. For example, commercially available DMDs can reach speeds of 10,000 frames per second. If 24 two-dimensional frames are used to create colour and grey-scale effects and a 3D image refresh rate of 50 Hz is required, it is possible to create eight different image planes 40a, 40b, 45a, 45b in the imaging volume 44, 49.

With reference to FIG. 6, a first arrangement of optical path length adjuster 53a is described. The optical path length adjuster is based on birefringent materials and polarisation switches.

Birefringent materials have different effective refractive indices depending upon the polarisation of the light impinging on the material. This difference may be significant. For instance, the well-known material calcite has a refractive index of nₑ=1.486 for light with polarisation parallel to the optic axis of the material, and nₒ=1.658 for light with the polarisation perpendicular (orthogonal) to the optic axis. The present invention is based on this property.

FIG. 6 illustrates this principle. The optical path length adjuster 150 comprises a polarisation switch 160 in an input optical path 52, in front of an optical element 161 that exhibits birefringent properties. An optical output path 54 is indicated from the output face of the birefringent optical element 161.

The expression ‘polarisation switch’ is used herein to encompass any suitable device for selecting for a specific polarisation state, e.g. a polarisation rotator that can be switched on and off, or into and out of the optical path. The polarisation switch may change the polarisation state of an already polarised beam, or may select a polarisation state from an unpolarised beam. Where light from the display panel 41, 51 is already polarised, then the polarisation switches can all be of the polarisation changing type.

The polarisation switch may be a single cell liquid crystal panel with a twisted nematic 90 degree structure or a ferro-electric effect cell which allows a higher switching speed. The polarisation switch generally provides a polarised optical output in one of two possible polarisation states, according to an applied electric field. In another alternative, a polarisation switch could be implemented using a rotatable wheel with two alternative polarisers.

The expression ‘birefringent optical element’ 161 is used herein to refer to an optical element which exhibits sufficient birefringent properties to enable the selection of at least two different effective optical path lengths therethrough by selection of the polarisation state of an incident light beam. The birefringent optical element may include focusing properties. The birefringent optical element may include portions thereof that do not exhibit birefringence as will be discussed hereinafter.

Due to the different refractive indices nₒ and nₑ in the birefringent optical element 161, the apparent (effective) optical path length therethrough is longer for light polarised in the direction 162 perpendicular to the optic axis 163 than for light polarised in the direction 164 parallel to the optic axis 163 (or vice versa, depending upon the crystal material). By switching the polarisation switch 160 to select the appropriate polarisation state, a short or a long optical path can be chosen.

Care should be taken in choosing the direction of the optic axis of the birefringent optical element. The effective index of refraction for p-polarised light can be dependent on the angle of incidence. This could be inconvenient in an imaging system. In a typical application, the birefringent element 161 is irradiated with light at several angles of incidence. Preferably the variation of the effective index of refraction for light with one polarisation (i.e. either the ordinary or extraordinary rays) should be minimised. This can be achieved by selecting the optic axis of the crystal as perpendicular to the optical axis of the system (i.e. orthogonal to the input path 52, as shown in FIG. 6).

In this situation, for polarised light perpendicular to the optic axis, the index of refraction of the birefringent element 161 is equal to the ordinary index of refraction nₒ of the birefringent element. For light polarised parallel with the optic axis 163 of the birefringent element 161, the situation is more complicated, as will be discussed in connection with FIG. 7.

FIGS. 7(a) and 7(c) show views of the birefringent optical element 161 in the direction parallel with the optic axis 163. FIGS. 7(b) and 7(d) show views of the birefringent optical element 161 in the direction perpendicular to the optic axis 163. The index of refraction depends on the propagation direction of the light. Note that the two values of the index of refraction for the input beam polarisation parallel to the optic axis are extreme values. For other propagation directions with the same angle θₑ, the index of refraction has a value between these two.

A practical embodiment is shown in FIG. 8. In this schematic representation, the ‘object’ may correspond to the display panel or light engine 51 which emits light along input optical path 52 to the birefringent optical element 161. Polarisation switch 160 selects for a desired polarisation state for the input beam. The position of the image 55, 55′ depends on the polarisation of the light selected.

The embodiment as shown in FIG. 8 can, generally speaking, only produce images in two different planes at 55, 55′. A series of N of these optical path length adjusters each with a birefringent optical element 161 having a thickness two times larger than the previous birefringent element will effectively result in 2^{N} different path lengths. For example, using eight polarisation switches 160 and eight birefringent optical elements 161, it is possible to realise 256 different image planes, provided that the polarisation of the rays through the birefringent optical components can be independently chosen and provided that problems with astigmatism can be avoided or corrected, as discussed later.

The invention may also be used in conjunction with the optical path length adjuster described in the co-pending application entitled “Optical Path Length Adjuster” as referenced above, and as briefly discussed below in connection with FIG. 9.

The optical path length adjuster in FIG. 9 comprises a first polarising beam splitter 61 and a second polarising beam splitter 62. A polarisation switch 60 is provided in front of the first beam splitter 61 in the input optical path 52.

The first beam splitter 61 has a first input surface 61a, and first and second output surfaces 61b, 61c respectively. The second beam splitter 62 has first and second input surfaces 62a, 62b and an output surface 62c. A first optical path 63 extends directly between the first output surface 61b of the first beam splitter 61 and the first input surface 62a of the second beam splitter. A second optical path 64 (longer than the first optical path 63) extends between the second output surface 61c of the first beam splitter 61 and a second input surface 62b of the second beam splitter 62. The output surface 62c of the second beam splitter couples to the output optical path 54.

By means of the polarisation switch 60, it is possible to select between the two different optical paths 63, 64 as follows. Let us assume that we start with an input beam of polarised light on input path 52, for instance with polarisation state P. The two different paths 63, 64 can be selected as follows. Firstly, if the polarisation switch 60 is switched off, P-polarised light will enter the first splitter 61 and is not reflected therein, passing straight through to path 63. The same condition holds for the second splitter 62. So, in this polarisation state, light travels along a straight line through the adjuster 53a.

If the polarisation switch 60 is switched on, the P-polarised input light beam will be converted to S-polarised. This polarisation will enter the first splitter 61 and it will be reflected to the right onto optical path 64. In the second splitter 62 this light will be reflected again and leave the adjuster 53a is along the output path 54.

In the configuration of FIG. 9, it will be noted that the second optical path 64 comprises three path segments 64a, 64b, 64c separated by two mirrors 66a, 66b. In other arrangements, there could be more, or fewer path segments.

By means of this adjuster 53a, we can create two image planes 55 in a volumetric display device 50.

Use of the adjuster 53a in conjunction with the birefringent adjuster 150 of the present invention is possible to increase the number of image planes.

A more sophisticated path length adjuster 100 using the principles of the arrangement of FIG. 9 is shown in FIG. 10. By means of four polarisation switches 101, 102, 103, 104 and just two polarising beam splitters 105, 106 it is possible to increase the number of different optical paths to seven. This is a particularly advantageous construction since large polarising beam splitters are relatively expensive.

Similar to the arrangement of FIG. 9, the input optical path 52 is directed to a first input surface 105a of the first beam splitter 105. The output optical path 54 is coupled to a first output surface 106c of the second beam splitter 106.

The first beam splitter 105 has first and second input surfaces 105a and 105d, and first and second output surfaces 105b and 105c. The second beam splitter 106 has first and second input surfaces 106a and 106b, and first and second output surfaces 106c and 106d. An array of mirrors 108a, 108b, 108c, 108d fold the various optical path segments to appropriate input surfaces of the beam splitters as shown. A first optical path 110 exists between the output surface 105b and the input surface 106a. A second optical path 111 exists between the output surface 105c and the input surface 106b. A third optical path 112 exists between the output surface 106d and the input surface 105d.

Each of the input surfaces 105a, 106b, 105d and 106a is associated with a respective one of the polarisation switches 101, 102, 103, 104.

In principle there are sixteen different states in which the four is polarisation switches can be deployed. Several of these states actually result in the same path for a light beam entering the adjuster. It can be shown that there are eight different paths and of these eight paths, seven have a different total path length. The eight distinct paths are shown in FIG. 11. Full details of these paths are found in the co-pending application referenced above.

It will be understood that the birefringent optical path length adjuster 150 of the present invention may also be used in conjunction with the adjuster of FIG. 10.

The different optical paths might result in brightness differences due to absorption coefficients of the polarisation switches 60, 101 to 104 and/or birefringent element 161 and/or splitters 61, 62, 105, 106. This absorption could be compensated for by the intensity of light engine display 51, e.g. corrected electronically in a video signal supplied thereto.

With reference to FIG. 12 a schematic view of an overall volumetric image display device using the birefringent optical path length adjusters described herein, together with control system, is shown. The path length adjuster 120 (e.g. adjuster 53, 150, 53a, 100 as described earlier) interposed between the 2D display panel 46 and focusing element 47 is controlled by path length control circuit 73. Path length control circuit provides drive signals to each of the polarisation switches. A display driver 72 receives 2D frame image data from image generator 71. Display of the succession of 2D images is synchronised with the path length controller operation by way of a synchronisation circuit 74.

The birefringent optical path length adjuster 150 described in connection with FIGS. 6, 7 and 8 generally suffers from aberrations. The extraordinary ray may be subject to astigmatism. Even when the angle θₑ is small (note that θₑ is defined with respect to the optical axis of the system), then the refraction by the crystal for the two situations in which the polarisation of the rays is parallel with the optic axis of the crystal may be significantly different, resulting in severe astigmatism of the beam focussed through the birefringent plane parallel plate. This astigmatism results in a ‘blur’ of the focus; which may completely overlap the ordinary focus. Thus, in many circumstances, the optical path length adjustment cannot usefully be performed without providing for correction of this astigmatism. There are several ways of correcting these aberrations as will be described.

Furthermore, spherical aberrations can be severe for a converging beam that travels through a plane-parallel plate. For the spherical aberrations, calculations have shown that optimising the spherical aberration correction for an ordinary beam also can result in a significant decrease of the spherical aberrations of the extraordinary beam.

In one arrangement, it is proposed to include a (non-birefringent) spherical aberration-correcting optical element in the optical path that corrects the spherical aberrations in the ordinary beam. Even when the rotation of polarisation is applied, and some plane-parallel plates are passed by an extraordinary beam, this spherical aberration correction is sufficient, provided the angle of incidence is not too large.

The propagation of light in birefringent materials is now briefly discussed with reference to FIG. 13. Following the reasoning as described in M. Born & E. Wolf, Principles of Optics, 7th Edition, CUP, 2001, p.806, we start with the Fresnel equation of wave normals:
sₓ²(vₚ²−v_{y}²)(vₚ²−v_{z}²)+s_{y}²(vₚ²−v_{z}²)(vₚ²−vₓ²)+s_{z}²(vₚ²−vₓ²)(vₚ²−vₓ²)=0 , (1)
where vₚ,vₓ,v_{y}, v_{z} are the phase velocity, and the three principal velocities of propagation, and Sₓ, S_{y},S_{z} are the components of the wave normal in the crystal. We assume the optic axis is in the x-direction, i.e.
vₓ=vₑ,and v_{y}=v_{z}=vₒ, (2)
where vₑ is the extraordinary velocity, and vₒ is the ordinary velocity.

Substituting these expressions in expression 1 results in:
sₓ²(vₚ²−vₒ²)(vₚ²−vₒ²)+s_{y}²(vₚ²−vₒ²)(vₚ²−vₑ²)+s_{z}²(vₚ²−vₑ²)(vₚ²−vₒ²)=0
,
and hence
vₚ²−vₒ²=0, or sₓ²(vₚ²−vₒ²)+s_{y}²(vₚ²−vₑ²)+s_{z}²(vₚ²−vₑ²)=0. (3)

The direction of the wave normal v in the crystal is characterised by the polar angle θ (w.r.t. the z-axis), and the azimuthal angle φ (w.r.t. the x-axis), i.e.
sₓ=sin θ cosφ,
s_{y}=sin θ sinφ,
and sₓ=cos θ . (4)

FIG. 13 shows the geometry.

Substituting these expressions in expression 3 results in
vₚ²−vₒ²=0,
or
sin²θ cos²φ(vₚ²−vₒ²)+sin²θ sin²φ(vₚ²−vₑ²)+cos ²θ(vₚ²−vₑ²)=0. (5)

The result is that the phase velocity obeys either
vₚ=±v_{o,}
or
vₚ=±\sqrt{v}ₒ²sin²θ cos²φ+vₑ²(sin²θsin²φ+cos²θ) (6)

We assume the normal of the crystal surface to be in the z-direction.

Then Snell's law can be written as

$$\frac{sin {θ}_{i}}{sin θ} = \frac{c}{{v}_{p}} . \qquad ( 7 )$$

Note that the azimuthal angle is equal in and outside the crystal. For the ordinary ray, Snell's law is

$$\frac{sin {θ}_{i}}{sin θ} = \frac{c}{{v}_{o}} = {n}_{o} , \qquad ( 8 )$$

where nₒ is the ordinary index of refraction. For example extraordinary ray.

Snell's law is

$$\frac{sin {θ}_{i}}{sin θ} = \frac{1}{\sqrt{{n}_{o}^{- 2} {sin}^{2} θ {cos}^{2} φ + {n}_{e}^{- 2} ( {sin}^{2} θ {sin}^{2} φ + {cos}^{2} θ )}} , \qquad ( 9 )$$

where nₑ is the extraordinary index of refraction. This expression can be solved for 0, resulting in:

$$sin θ = \pm \frac{sin θ}{{n}_{e} \sqrt{1 - {sin}^{2} {θ}_{i} {cos}^{2} φ ( {n}_{o}^{- 2} - {n}_{e}^{- 2} )}} , \qquad ( 10 )$$

which can be used to calculated the direction of the extraordinary wave normal in the crystal as a function of the wave normal outside the crystal. It can be rewritten in the same form as Snell's law, i.e.

$$\frac{sin {θ}_{i}}{sin θ} = {n}_{e} \sqrt{1 - {sin}^{2} {θ}_{i} {cos}^{2} φ ( {n}_{o}^{- 2} - {n}_{e}^{- 2} )} , \qquad ( 11 )$$

which reveals an important feature: the effective index of refraction is dependent on the angle of incidence and on the azimuthal angle of the incident wave.

We will now calculate the influence of birefringence on the refracted rays. The wave vector k̅ can be written as:

$$\vec{k} = \vert k \vert \cdot \vec{s} = \frac{2 π}{{λ}_{0}} \cdot \frac{{v}_{p}}{c} \cdot \vec{s} = \frac{ω}{{v}_{p} \cdot \vec{s}} \qquad ( 12 )$$

using
sₓ²(vₚ²−vₒ²)+s_{y}²(vₚ²−vₓ²)+s_{z}²(vₚ²−vₑ²)=0, (3)
we can derive the following expression for k̅

$${ω}^{2} [ {s}_{x}^{2} ( 1 - \frac{{v}_{o}^{2}}{{v}_{p}^{2}} ) + {s}_{y}^{2} ( 1 - \frac{{v}_{e}^{2}}{{v}_{p}^{2}} ) + {s}_{z}^{2} ( 1 - \frac{{v}_{e}^{2}}{{v}_{p}^{2}} ) ] = 0. \qquad ( 13 )$$

Since s̅ is a unit vector, this expression can be rewritten in

$${ω}^{2} [ 1 - {s}_{x}^{2} \frac{{v}_{o}^{2}}{{v}_{p}^{2}} - {s}_{y}^{2} \frac{{v}_{e}^{2}}{{v}_{p}^{2}} {s}_{z}^{2} \frac{{v}_{e}^{2}}{{v}_{p}^{2}} ] = 0 , \qquad ( 14 )$$

which can be rewritten in

$$\begin{matrix}⌊ {ω}^{2} - {k}_{x}^{2} \cdot {v}_{o}^{2} - {k}_{y}^{2} \cdot {v}_{e}^{2} - {s}_{z}^{2} \cdot {v}_{e}^{2} ⌋ = 0 , & ( 15 ) \\ and \frac{{k}_{x}^{2}}{{n}_{o}^{2}} + \frac{{k}_{y}^{2}}{{n}_{e}^{2}} + \frac{{k}_{s}^{2}}{{n}_{e}^{2}} - \frac{{ω}^{2}}{{c}^{2}} = 0. & ( 16 )\end{matrix}$$

The wave vector k̅ and the ray vector (=group velocity vector) v̅ are related in the following way [J.Opt.Soc.Am.A Vol19, No5, p814 (1992)]

$$\begin{matrix}\vec{v} = {\vec{▽}}_{k} \cdot ω , & ( 17 ) \\ i . e . \vec{v} = {\vec{▽}}_{k} \cdot c \sqrt{\frac{{k}_{x}^{2}}{{n}_{o}^{2}} + \frac{{k}_{y}^{2}}{{n}_{e}^{2}} + \frac{{k}_{z}^{2}}{{n}_{e}^{2}}} , & ( 18 )\end{matrix}$$

resulting in:

$$\overline{v} = \frac{{c}^{2}}{ω} ( \frac{{k}_{x}}{{n}_{o}^{2}} , \frac{{k}_{y}}{{n}_{e}^{2}} , \frac{{k}_{z}}{{n}_{e}^{2}} ) = \frac{{c}^{2}}{{v}_{p}} ( \frac{{s}_{x}}{{n}_{o}^{2}} , \frac{{s}_{y}}{{n}_{e}^{2}} , \frac{{s}_{z}}{{n}_{e}^{2}} ) \qquad ( 19 )$$

Note that the direction of the ray is different from the direction of the wave normal.

The angle ξ of the refracted ray with the normal of the surface is

$$tan ( ξ ) = \frac{\sqrt{\frac{{s}_{x}^{2}}{{n}_{o}^{4}} + \frac{{s}_{y}^{2}}{{n}_{e}^{4}}}}{\frac{{s}_{z}^{2}}{{n}_{e}^{2}}} . \qquad ( 20 )$$

Substituting the expressions for sₓ, s_{y}, in this expression results in

$$tan ( ξ ) = \frac{\sqrt{\frac{{sin}^{2} {θcos}^{2} φ}{{n}_{o}^{4}} + \frac{{sin}^{2} {θsin}^{2} φ}{{n}_{e}^{4}}}}{\frac{cos θ}{{n}_{e}^{2}}} = tan θ \cdot \sqrt{{( \frac{{n}_{e}}{{n}_{o}} )}^{4} {cos}^{2} φ + {sin}^{2} φ} . \qquad ( 21 )$$

The resulting expression as a function of θᵢ is

$$tan ( ξ ) = \frac{sin {θ}_{i}}{\sqrt{{n}_{e}^{2} ( 1 - {sin}^{2} {θ}_{i} {cos}^{2} φ ( {n}_{o}^{- 2} - {n}_{e}^{- 2} ) ) - {sin}^{2} {θ}_{i}}} \cdot \sqrt{{( \frac{{n}_{e}}{{n}_{o}} )}^{4} {cos}^{2} φ + {sin}^{2} φ} \qquad ( 22 )$$

For the extraordinary ray in the yz-plane (φ=90°), this expression is:

$$tan ( ξ ) = \frac{sin {θ}_{i}}{{n}_{e}^{2} - {sin}^{2} {θ}_{i}} , \qquad ( 23 )$$

while for the extraordinary ray in the xz-plane (φ=0°), this expression is:

$$tan ( ξ ) = ( \frac{{n}_{e}}{{n}_{o}} ) \cdot \frac{sin θ}{\sqrt{{n}_{o}^{2} - {sin}^{2} {θ}_{i}}} . \qquad ( 24 )$$

For the ordinary ray, the corresponding expression is

$$tan ( ξ ) = \frac{sin {θ}_{i}}{\sqrt{{n}_{o}^{2} - {sin}^{2} {θ}_{i}}} . \qquad ( 25 )$$

The difference between the ordinary and the extraordinary rays can be used to change the position of the focus of a converging beam. A drawback of the birefringent crystal is the astigmatism in the extraordinary ray, i.e. the difference in the refracted ray direction for the rays in the xz-plane and the yz-plane. FIG. 14 shows a converging beam 140 in a calcite crystal 141. The middle lines 142 represent the ordinary ray. The outer lines 143 and the inner lines 144 represent the extraordinary rays in the xz-plane and the yz-plane respectively. For clarity, both extraordinary rays are actually drawn in the same plane in the diagram.

It is clear in FIG. 14 that the position of the focus 145 as created by a converging beam 140 can be changed. However, switching from the ordinary to the extraordinary beam results in astigmatism that may completely overlap the ordinary focus.

The expression for the distance between the focus 146 without the birefringent crystal (as indicated with dotted lines) and the focus 145 with the birefringent crystal is

$${δ}_{e , o} = d ( 1 - \frac{tan {ξ}_{e , o}}{tan {θ}_{i}} ) ,$$

where d is the thickness of the crystal 141. From this expression, it is clear that spherical aberrations are also introduced by the crystal, since the ‘focal distance’ δ is a function of the angle of incidence. FIG. 15 shows the displacement of the focus as a function of the angle of incidence for the ordinary and the extraordinary rays with azimuthal angles 0 and 90 degrees for a calcite crystal of thickness 10 mm (nₒ=1.4864 and nₑ=1.6584). Line 182 illustrates the focus displacement for an ordinary ray with azimuth angle of 0 degrees. Line 183 illustrates the focus displacement for an extraordinary ray with azimuth angle of 0 degrees. Line 181 illustrates the focus displacement for an extraordinary ray with azimuth angle of 90 degrees.

In a first arrangement, the astigmatism can be corrected by adding anamorphic optical power to the birefringent optical element 141 or 161. A suitable arrangement is shown in FIG. 16 in which one of the surfaces of the birefringent element 165 is cylindrically shaped with a fitting, non-birefringent counterpart element 166 attached to it. The index of refraction of the counterpart element 166 should match the ordinary index of refraction of the birefringent element 165. Then the ordinary ray is not affected by the curved surface, while the foci of the extraordinary rays in both planes can be matched.

In order to simulate this principle, we assume the incoming extraordinary ray in the xz-plane to be defocused before the birefringent crystal is reached. We assume a constant defocus term, chosen in such a way that for paraxial rays, the foci of the extraordinary rays match. FIG. 17 shows the resulting focal displacements as a function of angle of incidence. Curve 186 represents the focal displacement for an ordinary ray with azimuth angle of 0 degrees. Curve 184 represents the focal displacement for an extraordinary ray with azimuth angle of 0 degrees. Curve 185 represents the focal displacement for an extraordinary ray with azimuth angle of 90 degrees.

A potential disadvantage of a cylindrical lens system 165, 166 is its complexity, and its small focal shift of approximately 0.7 mm for 10 mm thick birefringent material (e.g. calcite). Another potential disadvantage is the fact that the astigmatism can only be corrected for a certain object distance. Changing the object distance away from the position the birefringent optical element is corrected for will result in astigmatism.

In another embodiment, instead of using a plane-parallel birefringent element 161, a birefringent spherical lens 201 may be used, as shown in FIG. 18a. In FIG. 18a, a piano-convex birefringent lens is used, but other configurations may be used. The optic axis of the birefringent element material 201 is assumed to be parallel to the x-axis. Preferably, the spherical lens is configured so that the astigmatism of the extraordinary rays is minimised. A more detailed simulated view of the plano-convex spherical birefringent lens 201 is shown in FIG. 18b, having the flat surface positioned at y=0, the ordinary image at y=−38.0 mm, the extraordinary focus at y=−35.9 mm, and the original object (virtually) at y=−44.9 mm. The extraordinary rays are indicated by line 208 and the ordinary rays by line 209. Note that the focus of both extraordinary rays overlaps.

Using the theory as given above, the focal distance of this lens 201 can be calculated. The lens 201 creates a difference in focus for the two extraordinary rays. Calculations however have shown that for a certain object distance sₒ, and a certain cone of rays 202, the astigmatic aberration is absent. FIG. 19 illustrates this principle, for a piano-convex calcite lens 201 of 5 mm thickness, 100 mm radius of curvature, and an object positioned at y=−44.9 mm. In this figure, the image distance sᵢ is plotted for the ordinary and the extraordinary rays, using the thin lens approximation. Curve 190 represents the image distance as a function of angle of incidence for an ordinary ray with azimuth angle of 0 degrees. Curve 192 represents the image distance as a function of angle of incidence for an extraordinary ray with azimuth angle of 0 degrees. Curve 191 represents the image distance as a function of angle of incidence for an extraordinary ray with azimuth angle of 90 degrees.

It is clear from FIG. 19 that the two extraordinary ray curves cross at 15 degrees angle of incidence. This angle can be tuned by choosing the proper object 51 distance and/or the shape of the birefringent lens (e.g. the radius of curvature). In other words, the polar angle for which the two extraordinary rays have a common image distance can be given a value other than 15 degrees, by changing the object distance or lens shape. Thus, the astigmatism can be minimised by choosing an appropriate optimum object distance for the display 51.

The image shifts approximately 2 mm when changing from the ordinary ray to the extraordinary ray. Note that next to the spherical lens, it is also possible to use aspherical lenses.

A disadvantage of these methods to correct or eliminate astigmatism is the fact that the best fit for minimum astigmatism depends on the object distance. This means that if a cascade of birefringent path length adjusters is used, independent use of the separate adjusters may change the focus of the beam as seen by a subsequent adjuster in the cascade. This may limit the switching modes that can be used, especially for birefringent plane-parallel plates, where the astigmatism may be larger than the change in focus from the ordinary to the extraordinary rays.

For a birefringent spherical lens as described above, this problem is less severe since the astigmatism is much smaller than the image distance difference.

In a cascade of birefringent lenses, the lenses can be switched independently. Care should be taken that the optimal object distances and the image distances of adjacent lenses match as closely as possible, at least for the ordinary ray. This means that the image created by the first lens is near the position of the optimal object of the second lens, and so on. This scheme results in 2^{N} image distances for N birefringent lenses.

A possible switching scheme for the birefringent plane-parallel plate is that all of the path length adjusters are switched to the ordinary mode, except for one single adjuster which is passed using the extraordinary mode. Changing the adjuster which is passed in the extraordinary mode will change the optical path length. This scheme results in N image distances for N birefringent plane-parallel plates.

In FIGS. 17 and 19 spherical aberration is still apparent, especially at larger angles of incidence. It can be seen that the shape of the three curves in both figures is similar. Therefore, compensating the spherical aberrations for the ordinary ray will compensate a large fraction of the spherical aberrations of the extraordinary rays, especially in respect of relatively small angles of incidence.

Thus, in a further preferred arrangement, the birefringent path length adjuster includes a spherical aberration correction element and a birefringent element, as shown in FIGS. 20a and 20b. In the first arrangement of FIG. 20a, a spherical, non-birefringent lens element 203 is introduced for generating spherical aberration that compensates for that introduced by the cylindrically corrected, plane parallel birefringent element 204 (as previously described in connection with FIG. 16). In the second arrangement of FIG. 20b, a plane-parallel, non-birefringent element 205 is introduced for generating spherical aberration that compensates for that introduced by the birefringent spherical lens 206 (as previously described in connection with FIGS. 18a and 18b).

The two elements 205, 206 could be combined by mounting them together. The two elements 203, 204 could be combined by mounting them together or by forming the non-birefringent part of the cylindrically corrected element 204 and the spherical lens 203 as one piece. For both the ordinary and the extraordinary rays, the spherical aberrations are sufficiently corrected.

In FIG. 15, it is clear that for the outer rays (those having the largest angle of incidence), the focus displacement induced by the birefringent plane-parallel element 161 is larger than for the inner rays (those with a smaller angle of incidence). This is exactly opposite to the situation in which a spherical lens creates a focus. There, as shown for instance in FIG. 19, the focus of the outer rays is closer to the lens than the focus of the inner rays. Therefore, a non-birefringent or birefringent spherical lens (e.g. lens 201) can be used to compensate the spherical aberrations of the ordinary ray.

In FIG. 19, the outer rays are focused closer to the lens than the inner rays, as is normal with spherical lenses. This spherical aberration can (partly) be corrected by adding a plane-parallel plate in the converging beam.

For both cases, aspherical surfaces can also correct the spherical aberrations.

FIG. 21 shows the distance δ between the ordinary focus and the extraordinary focus (hereinafter ‘inter-focus distance’) for a plane-parallel birefringent element 161 (FIGS. 8 and 14) as a function of angle of incidence. Curve 210 represents the inter-focus distance for extraordinary ray with azimuth angle of 0 degrees. Curve 211 represents the inter-focus distance for extraordinary ray with azimuth angle of 90 degrees.

Assuming that the spherical aberration correction element corrects all the spherical aberrations of the ordinary ray, then the variation in δ as a function of θ in FIG. 21 is a measure of the spherical aberrations of the extraordinary rays. Up to an angle of incidence of 10 degrees, these aberrations are rather small. At 10 degrees angle of incidence, the focus has shifted 0.007 mm, and 0.002 mm for 0, and 90 degrees azimuth angle respectively.

FIG. 22 shows the difference in image distance between the extraordinary images and the ordinary image. Curve 220 represents the difference in image distance (Δsᵢ) between the ordinary ray image and the extraordinary ray image where the extraordinary ray has an azimuth angle of 0 degrees. Curve 221 represents the difference in image distance (δsᵢ) between the ordinary ray image and the extraordinary ray image where the extraordinary ray has an azimuth angle of 90 degrees.

It is clear that the extraordinary ray having azimuth angle φ=90 degrees still suffers from spherical aberrations. However, by tuning the intersection point of the two extraordinary curves 220, 221, this spherical aberration can be minimised. For example, as previously discussed, for a birefringent lens there is a combination of object distance, lens shape (e.g. thickness and radius of curvature) and angle of incidence that results in no astigmatism of the rays with this angle of incidence and object distance. By changing either the object distance or the lens shape, the angle of incidence where no astigmatism occurs changes.

In summary, the present disclosure proposes to use birefringent optical components to adjust the optical path length. Astigmatism is a severe problem of such optical components. As described herein, this can be minimised using a cylindrically corrected plane parallel plate or a spherical birefringent lens.

Also disclosed is a method to correct the spherical aberrations of the birefringent element. Correcting the spherical aberrations for the ordinary rays in the birefringent plane-parallel element, may also correct the aberrations of the extraordinary ray sufficiently, provided that the angle of incidence is not too large. The result is an aberration corrected optical pathlength adjuster, which introduces only small aberrations in each ‘switching state’.

Although a-principal and important use for the path length adjusters as described herein is in the application of a volumetric three dimensional image display device, it will be recognised that the adjusters may have use in other optical instruments and devices, where it is necessary or desirable to facilitate is the electro-optical switching of an optical path length between two optical elements. Such an arrangement avoids the need for moving parts as the path length can be varied by way of electrical control signals to each of the polarisation switches.

Although various optical techniques have been described for correcting or minimising aberrations introduced by certain configurations of birefringent optical path length adjusters, it will be noted that correction or further correction of aberrations may be possible electrically. For example, some corrections may be made by effecting alterations in images displayed on the display device 51 as a function of whether the image will be passed as an extraordinary ray or ordinary ray (i.e. as a function of the switching condition of the polarisation switch or switches).

Other embodiments are intentionally within the scope of the accompanying claims.

1. A display device for generating a three-dimensional volumetric image, comprising:
a two-dimensional image display panel (41, 46) for generating a two-dimensional image;
a first focusing element (42, 47) for projecting the two-dimensional image to a virtual image (40, 45) in an imaging volume (44, 49); and
means (53, 120, 150) for altering the effective optical path length between the display panel and the projecting first focusing element so as to alter the position of the virtual image within the imaging volume, wherein the means for altering the effective optical path length includes an optical path length adjuster for varying an effective optical path length between an input optical path (52) and an output optical path (54), comprising:
a first polarisation switch (160) for selecting a polarisation state for an input beam on the input optical path (52); and
an optical element (141, 161, 201) having birefringent properties and thereby defining at least two possible effective optical paths of different lengths therethrough, for passing the input beam along a selected one of said at least two possible optical paths according to the selected polarisation state of the input beam and for providing an output beam of light, on said optical output path (54), that has travelled along the selected optical path.

2. The apparatus of claim 1 in which the birefringent optical element (161) has its optic axis orthogonal to the optical axis defined by the input path (52) and the output path (54).

3. The apparatus of claim 1 further including an optical element (165), 201) for at least partially correcting for astigmatism.

4. The apparatus of claim 3 in which the birefringent optical element (165) includes a cylindrically-shaped optical surface for correcting for astigmatism.

5. The apparatus of claim 4 in which the birefringent optical element (165) further includes a fitting, non-birefringent counterpart element (166) attached to the cylindrically-shaped optical surface.

6. The apparatus of claim 5 in which the counterpart element (166) has a refractive index substantially equal to the ordinary index of refraction of the birefringent element (165).

7. The apparatus of claim 3 in which the birefringent optical element comprises a spherical lens (201).

8. The apparatus of claim 7 in which the spherical lens is a plano-convex lens (201).

9. The apparatus of claim 1 further including an optical element for at least partially correcting for spherical aberration.

10. The apparatus of claim 9 in which the birefringent optical element is a cylindrically corrected plane-parallel plate and in which the spherical aberration correction element is a spherical lens.

11. The apparatus of claim 9 in which the birefringent optical element is a spherical lens and in which the spherical aberration correction element is a plane-parallel plate.

12. The apparatus (53, 150) of claim 1 combined with at least one further optical path length adjuster (53, 150) of any preceding claim in a cascade formation, such that the output optical path (54) of the first said optical path length adjuster (150) forms the input path (52) of a successive said further optical path length adjuster (53, 150).

13. The apparatus of claim 12 in which the optical paths of each said optical path length adjuster (53, 150) include different optical path lengths such that a plurality of possible overall optical path lengths are selectable by appropriate selection of path length within each said optical path length adjuster.

14. The apparatus of claim 13 in which each successive optical path length adjuster in the cascade has a thickness of birefringent optical element which is different from any other birefringent optical element in the cascade.

15. The apparatus of claim 1 including a further optical path length adjuster, the further optical path length adjuster comprising:
a first polarisation switch (60) for selecting a polarisation state for an input beam on an input optical path (52); and
first and second beam splitters (61, 62, 105, 106) having at least two possible optical paths (63, 64, 110, 111, 112) of different lengths therebetween, for passing the input beam along a selected one of said at least two possible optical paths according to the selected polarisation state of the input beam and for providing an output beam of light, on an optical output path (54), that has travelled along the selected optical path.

16. The apparatus of claim 15 in which the first beam splitter (105) has a first optical input (105a) coupled to the optical output of the first polarisation switch (101), for diverting light at the optical input of the first splitter to first and second optical outputs (105b, 105c) respectively according to a polarisation state of the light at the optical input of the first splitter;
the second beam splitter (106) has first and second optical inputs (106a, 106b) respectively optically coupled to the first and second outputs (105b, 105c) of the first beam splitter (105), via respective said first and second optical paths (110, 111), the second beam splitter (106) diverting light at the first and second inputs (106a, 106b) to first and second outputs (106c, 106d) of the second beam splitter (106) according to a polarisation state of light at the first and second inputs thereof;
the first output (106c) of the second beam splitter (106) defines the optical output path (54), and the second output (106d) of the second beam splitter is optically coupled to a second input (105d) of the first beam splitter (105) via a third optical path (112);
each of the first, second and third optical paths (110, 111, 112) respectively includes one of a second, a third and a fourth polarisation switch (104, 102, 103),
the first, second, third and fourth polarisation switches adapted to thereby select cumulative combinations of one or more of said first, second, and third optical paths between the input optical path (52) and the output optical path (54).

17. The display device of claim 3 in which the display panel (51) is positioned at a distance from the birefringent optical element (141, 161, 201) such that astigmatic aberration is substantially minimised or eliminated.

18. The display device of claim 3 in which the display panel (51) is positioned at a distance from the birefringent optical element (141, 161, 201) such that spherical aberration is substantially minimised or eliminated.

19. The display device of claim 9 in which the display panel (51), the birefringent optical element (141, 161, 201) and the spherical aberration correction element (203, 205) are relatively positioned such that spherical aberration is substantially minimised or eliminated.

20. A method for generating a three-dimensional volumetric image, comprising the steps of:
generating a two-dimensional image on a two-dimensional image display panel (41, 46);
projecting the two-dimensional image to a virtual image (40, 45) in an imaging volume (44, 49) with a first focusing element (42, 47); and
altering the optical path length between the display panel and the projecting focusing element so as to vary the position of the virtual image within the imaging volume by varying an effective optical path length between an input optical path (52) and an output optical path (54) of an optical path length adjuster (53, 150, 120) positioned between the display panel and the projecting focusing element, comprising the steps of:
selecting a polarisation state for an input beam of light on the input optical path using a first polarisation switch (160);
passing the input beam into an optical element having birefringent properties and thereby defining at least two possible effective optical paths of different lengths therethrough, the input beam travelling along a selected one of said at least two possible effective optical paths according to the selected polarisation state of the input beam; and
providing an output beam of light, from the birefringent optical element on said optical output path (54).

21. The method of claim 20 further including the step of at least partially correcting for astigmatism.

22. The method of claim 20 further including the step of at least partially correcting for spherical aberration.

23. The method of claim 20 further including the step of passing the beam through at least one further optical path length adjuster such that the output optical path (54) of the first said optical path length adjuster (150) forms the input path (52) of a successive said further optical path length adjuster (53, 150), and selecting optical path length using each optical path length adjuster.

24. The method of claim 20 further including the step of positioning the optical path length adjuster at a distance from an object to be imaged so as to minimise astigmatic aberration.

25. The method of claim 20 further including the step of positioning the optical path length adjuster relative to an object to be imaged so as to minimise spherical aberration.

26. The method of claim 23 further including the step of selecting different optical path lengths within each said optical path length adjuster (53a, 53b).
